(19) United States
(12) Patent Application Publication
(10) Pub. No.: US 2007/0293614 A1
(43) Pub. Date: Dec. 20, 2007

(54) Powder coating composition for pipe coating

(76) Inventors: Wenjing J. Zhou, Cypress, TX (US); Thomas E. Jeffers, Houston, TX (US); Owen H. Decker, Houston, TX (US); Stephen J. Edmondson, Oakville (CA)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/807,868

(22) Filed: May 30, 2007

Related U.S. Application Data
(60) Provisional application No. 60/813,942, filed on Jun. 15, 2006.

(51) Int. Cl. C08K 3/38; B29B 9/02; C08G 67/00

(52) U.S. Cl. 524/405; 264/141; 524/612

(57) ABSTRACT

The present invention provides an epoxy powder coating composition comprising an intimate mixture comprising
(A) 5 to 99 wt % of at least one bromine functionalized epoxy resin with a bromine content of 5 to 60 % based on component (A),
(B) 0.5 to 40 wt % of at least one epoxy curing agent, and
(C) 0.01 to 55 wt % of at least one pigment, filler and/or coating additive,

the wt % based on the total weight of the powder coating composition.

The powder coating composition of this invention provides coating with a high glass transition temperature and acceptable flexibility when coated on metallic or plastic substrates, particularly metallic and plastics pipelines. The coatings may have an improved adhesion under hot and humid conditions as well as an optimum short and long term high temperature and humidity cathodic disbondment protection.

### CROSS-REFERENCE TO RELATED APPLICATION

This application claims the benefit of U.S. Provisional Application Ser. No. 60/813,942 filed on Jun. 15, 2006 which is hereby incorporated by references in its entirety.

### FIELD OF THE INVENTION

The present invention is directed to an epoxy powder coating composition for the use in pipe coating applications having a glass transition temperature higher than 120° C. providing acceptable flexibility of the coating as well as improved adhesion to the substrate under hot and humid conditions.

### DESCRIPTION OF PRIOR ART

Epoxy resins are well-known as binder resins in the preparation of powder coatings, see D. A. Bate, The Science of Powder Coatings, Vol. 1, 1990, pages 23-38.

Generally, the adhesion of epoxy powder coating compositions to the substrate is adequate, and they have been improved in the past. U.S. Pat. No. 4,678,712 and U.S. Pat. No. 4,330,644 disclose various rebar and pipe epoxy powder coating compositions that have been pre-reacted with a hydroxyl amine to improve adhesion.

Epoxy powder coatings have also been used in the past on gas and oil pipelines to prevent corrosion, as well as, facilitate cathodic protection of the pipe. Cathodic protection is another means for preventing corrosion of iron containing metallic materials, such as steel in humid conditions containing electrolytes, i.e., brine and salt solutions. In general, cathodic protection prevents dissolution of the iron containing metallic material by maintaining the material as a cathode and inhibiting ionization of the iron contained therein. Unfortunately, cathodic disbanding and degradation of adhesion of the organic coating may occur.

To restrict cathodic disbanding JP-A 59-222275 proposes using a chromate treatment method, or a zinc-rich primer coating of a specific thermosetting epoxide resin, and JP-A 55-142063 proposes using a composition consisting of a polyvinyl butyral resin, a liquid epoxide resin, a borate compound, an epoxy-silane coupling agent and phosphoric acid as a pre-treatment composition for baking type. EP-A 0 588 318 mentions a method for providing cathodic protection that involves using steel pre-treatment steps, applying a thermosetting epoxide resin based powder coating containing 5 to 75 wt. % zinc compounds, and subsequently polarizing the coated steel material as a cathode.

U.S. 20040211678 discloses a cathodic corrosion protection composition comprising zinc borate for improving resistance to cathodic disbandment. U.S. 20050075430 describes a curable epoxy powder coating composition comprising alkanolamine. Such coatings provide an improved adhesion to the substrate under hot and humid conditions, and, in addition, they may be usable to give coatings with high cathodic corrosion protection. U.S. Pat. No. 4,853,297 mentioned liquid compositions based on epoxy resins including brominated epoxy resins for metal pipe application.

However, most epoxy powder coatings for pipe have a glass transition temperature (Tg) of about 110° C. after curing. When the coating is subjected to higher temperature service than its Tg, the coating will turn soft and loose its adhesion to the substrate under either dry or wet conditions, a common defect of the prior art for pipe coatings. Therefore, there is a need in the pipeline industry for a high Tg fusion bond to be used in high temperature environments. While current technology can produce high Tg products, they do not offer the level of flexibility and adhesion to steel required by the pipeline industries. Accordingly, there is a need for powder coating compositions, and methods of application thereof, that provide a high glass transition temperature with acceptable flexibility of the coating besides optimum short and long term high temperature and high humidity cathodic disbandment protection as well as high adhesion to the substrate.

### SUMMARY OF THE INVENTION

The present invention provides an epoxy powder coating composition comprising an intimate mixture comprising
(A) 5 to 99 wt % of at least one bromine functionalized epoxy resin with a bromine content of 5 to 60% based on component (A),
(B) 0.5 to 40 wt % of at least one epoxy curing agent, and
(C) 0.01 to 55 wt % of at least one pigment, filler and/or coating additive,
   the wt % based on the total weight of the powder coating composition and the sum of the components equals 100 wt %.

The powder coating composition of this invention provides a coating with a high glass transition temperature and acceptable flexibility when coated on metallic or plastic substrates, particularly metallic and plastics pipelines. The coatings may have an improved adhesion under hot and humid conditions as well as an optimum short and long term high temperature and humidity cathodic disbondment protection.

The coatings prepared in accordance with the present invention may also exhibit excellent adhesion when applied to metal surfaces that have been subjected to less than ideal surface preparation. Such surfaces include, for example, a steel surface that has been blasted but not acid rinsed, a steel surface that has been pre-heated to a lower than normal application temperature (substrate temperature before the powder composition was applied), and a steel surface that has been cleaned but not chemically pre-treated.

The coating compositions of the present invention may not only exhibit improved adhesion, but the improved adhesion may be realized at lower application temperatures than the application temperatures of presently available powder coating compositions that have been viewed as having good adhesion. Indeed, good adhesion can previously be obtained by applying the coating composition at temperatures of over 230° C. (446° F.), for example, in case of pre-heated substrates. As a result, the coating compositions of the present invention can provide significant energy savings, and therefore costs.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

Slight variations above and below the stated ranges of numerical values can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The present invention relates to a powder coating composition comprising 5 to 99 wt % of at least one bromine functionalized epoxy resin and an effective amount of an epoxy curing agent to cure the composition according to the invention. The present invention will produce a coating with a glass transition temperature higher than 120° C. with acceptable flexibility of the coating especially on metallic and plastic pipelines.

The bromine functionalized epoxy resins that may be used in accordance with the present invention include any epoxy resin, or mixtures thereof, that are well-known for a person skilled in the art and that are capable of being bromine functionalized. The bromine content of the epoxy resin is preferred in the range of 5 to 60%, particularly preferred in the range of 20-55% based on component (A).

Examples of such resins include brominated phenol novolac epoxy functional resins, brominated cresol novolac epoxy functional resins, epichlorohydrin epoxy functional resins, brominated di-glycidyl ethers of 4,4-(bishydroxyphenyl) alkanes or mixtures thereof. Preferably, the epoxy resin is a brominated bisphenol-A/ epichlorohydrin epoxy functional resin.

The brominated phenol novolac epoxy functional resins of the present invention can be prepared by reacting brominated phenol novolac resins with epichlorohydrin or by reacting brominated phenol novolac resins in mixture with phenol novolac resins with epichlorohydrin. In some cases, such epoxy phenolic novolac resins are blended with standard bisphenol-A epoxy resins or brominated standard bisphenol-A epoxy resins. A person of ordinary skill in the art is familiar with the commercially available resins that can be used in accordance with the invention.

The brominated cresol novolac epoxy functional resins of the present invention can be prepared by reacting a brominated cresylic novolac resin with epichlorohydrin or by reacting a brominated cresylic novolac resin in mixture with a cresylic novolac resin with epichlorohydrin. A person of ordinary skill in the art is familiar with the commercially available resins that can be used in accordance with the invention.

The brominated bisphenol-A/ epichlorohydrin epoxy functional resins of the present invention can be prepared by reacting brominated bisphenol-A with epichlorohydrin or by reacting brominated bisphenol-A in mixture with bisphenol-A with epichlorohydrin. A person of ordinary skill in the art is familiar with the commercially available resins that can be used in accordance with the invention. For example, brominated bisphenol-A/epichlorohydrin epoxy functional resins are marketed under the name EPON® by Hexion Specialty Chemicals, such as EPON® 1163 and EPON® 1183, EPOKUKDO® by KUKDO Chemical CO, LTD, such as EPOKUKDO® YDB-400H, YDB-406, YDB408, YDB412, KB-560, YDB-416, KB-562P and KB-563P, Aradite® by Huntsman International LLC, such as Aradite® 8049; D.E.R.™ by Dow Chemical Co. such as DER 542 and DER 560. Nan-Ya® by Anwin Enterprises Co., Ltd, such as Nan-Ya® NPEB-340, NPEB-400, NPEB-408, NPEB-450, NPEB460, NPEB-530H.

Preferably, the coating compositions of the present invention contain from 5 to 99 wt %, preferably 25-80%, most preferably 40-70% based on total weight of the coating composition, of a brominated epoxy resin, or mixtures thereof. The bromine functionalized epoxy resin may be partially replaced by non-brominated epoxy or additional resins such as, for example, diglycidyl ethers of bisphenol, epoxy novolack and other resins containing epoxy groups, polyester resins, (meth)acrylic resins, silicone resins, urethane resins and/or modified copolymers thereof in quantities in the range of 0 to 94 wt %, based on the total weight of the powder coating composition, and, optionally, curing agents to crosslink these further resins.

Thermoplastic polymers useful in the composition of the present invention may include, but are not limited to, an acrylonitrile/butadiene based compound that is available, for example, as Zealloy® 1411 from Zeon Chemical, for example, in the range of 0.1 to 5 wt % based on the total weight of the powder coating composition.

The epoxy curing agent, or mixtures thereof, that may be used in accordance with the present invention include, but are not limited to amines, such as, aromatic amines; acid anhydrides; acids; aromatic acids; mercaptans; phenolics; accelerated and/or modified dicyandiamides having addition reactivity and self-poly addition catalytic activity between epoxy groups and the derviatives thereof; imidazoles; imidazole adducts; hydrazides and so forth. Preferably, the epoxy curing agent is a dicyandiamide functional epoxy curing compound or a phenolic functional epoxy curing compound, or a mixture thereof. More preferably, the epoxy curing agent is an amino functional epoxy curing compound.

A person of ordinary skill in the art is familiar with the commercially available curing agents that can be used in accordance with this invention. For example, various amine adducts are marketed under the names SUNMIDE® by Sanwa Chemical Industry Co. Ltd., DYHARD® 100S by Degussa and EPICURE™ by Resolution Performance Products, LLC; various acid anhydrides are marketed under the name RIKASHIDE by New Japan Chemical Co., Ltd.; and various phenolics are marketed under the name DURITE® by Borden Chemical Co, Aradur® 9690 by Huntsman Advanced Materials Americas Inc., and under the name D.E.H.™ by Dow Chemical Company.

The curing agent is incorporated into the coating compositions of the present invention in an amount effective to cure the coating. Preferably the coating composition contains from 0.5 to 40 wt %, more preferably from 1.5 to 20 wt %, most preferably from 1.5 to 6.0 wt %, based on total weight of the coating composition, of a curing agent, or mixtures thereof.

The ratio of the curing agent to reactive resin component of the coating composition is preferably (0.5 to 1.1):1.0, more preferably (0.7 to 0.9):1.0, in terms of the equivalent ratio of the reactive group of the curing agent and the epoxy functional groups capable of reacting with the reactive group of the curing agent.

The coating compositions of the present invention may further comprise one or more pigments, fillers and/or coating additives, including, but not limited to dyes, fillers, flow control agents, dispersants, thixotropic agents, adhesion promoters, antioxidants, light stabilizers, thermoplastic polymers, curing catalysts, anticorrosion agents and mixtures thereof.

The coating composition of the present invention contains from 0.01 to 55 wt %, preferably from 5 to 35 wt %, based on total weight of the powder coating composition, of pigments, fillers, coating additives or mixtures thereof.

Pigments useful in the present invention include, but are not limited to, titanium dioxide, iron oxide, aluminum, bronze, phthalocyanine blue, phthalocyanine green and mixtures thereof. Fillers useful in the present invention, include but are not limited to, talc, alumina, calcium oxide, calcium silicate, calcium metasilicate, barium sulfate, aluminum silicate, barytes, mica, silica, and mixtures thereof.

Flow control agents and thixotropic agents are based, for example, on modified bentonites or silicas.

Anticorrosion agents include, but are not limited to, anticorrosion pigments, such as phosphate containing pigments; and other organic or inorganic corrosion inhibitors, such as, for example, salts of nitroisophthalic acid, phosphoric esters, amines and substituted benzotriazoles.

Catalysts suitable for use in the present invention include those that are capable of affecting a reaction between the epoxy group of the epoxy resin, the amine hydrogens of the amine functional curing agents, the phenolic hydroxyl groups of the phenolic compounds and homopolymerization of the epoxy resin. These catalysts include, but are not limited to, the onium compounds; imidazoles; imidazolines; and tertiary amines and phosphines. Preferably, the catalyst used is a solid at room temperature, and is selected from imidazoles and the solid phosphines. The catalyst is incorporated into the coating composition of the present invention in an amount effective to initiate curing of the coating as known by a person of ordinary skill in the art. A person of ordinary skill in the art will further recognize that some curing agents, such as Epicure™ Curing Agent P-101 by Resolution Performance Products, LLC can act as both a curing agent and as a catalyst.

The powder coating composition according to the invention may further comprise 0.02 to 6 wt %, based upon total powder coating composition, of at least one alkanolamine as component (D). Therefore, this invention also relates to a powder coating composition providing coatings having excellent adhesion in hot and humid conditions and improved resistance to cathodic disbandment in short term high temperature and humidity conditions.

Alkanolamines that may be used in accordance with the invention include, but are not limited to, those having the following formulas:

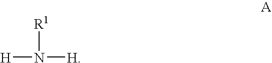

where R¹ is a linear or branched alkyl group of 1 to 10 carbons, preferably 2 to 8 carbons, and more preferably 2 to 4 carbons that contains at least one primary hydroxyl group; and

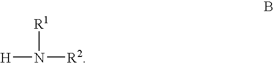

where R¹ is a linear or branched alkyl group of 1 to 10 carbons, preferably 2 to 8 carbons, and more preferably 2 to 4 carbons that contains at least one primary hydroxyl group and R² is a linear or branched alkyl group of 1 to 10 carbons, preferably 2 to 8 carbons, and more preferably 2 to 4 carbons that contains at least one primary hydroxyl group.

The alkanolamines used in accordance with the present invention can be in either liquid, or solid form. A person of ordinary skill in the art is familiar with the techniques that can be utilized to incorporate liquid alkanolamines into the powder mixture. For example, prior to adding the liquid alkanolamine to the powder coating mixture of the present invention, the liquid alkanolamine can be absorbed onto an inert carrier, such as silica.

Preferably, the alkanolamines of the present invention include, but are not limited to diethanolamines, ethanolamines, 2-amino-1-butanol, 2-amino-2-methyl-1-propanols, 2-amino-2-ethyl-1,3-propanediols, tris(hydroxymethyl) aminomethanes, 2-amino-2-methyl-1,3-propanediols, monomethylamino ethanols, isopropylaminoethanols, t-butylaminoethanols, ethylaminoethanols, n-butylaminoethanols, isopropanolamines, diisopropanolamines, and mixtures thereof. Preferred are diethanolamines, tris(hydroxymethyl)aminomethanes, such as, available under the trade names TRIS AMINO® by Dow Chemical Co. and Diethanolamine by Aldrich Chemical Co., and mixtures thereof.

Preferably, the coating compositions of the present invention contain from 0.1 to 3.0 wt %, more preferably from 0.1 to 0.5 wt %, based on total weight of the coating composition, of an alkanolamine, or mixtures thereof.

The powder coating composition according to the invention may further comprise 0.5 to 5 wt %, based upon total powder coating composition, of at least one zinc borate compound. Therefore this invention also relates to a powder coating composition providing improved resistance to cathodic disbandment, in especially long term high temperature and humidity conditions, such that the adhesion of the epoxy powder coating composition of the present invention to the substrate is improved.

Zinc borate compounds useful in accordance with the present invention included, but are not limited to, zinc metaborate [Zn(BO₂)₂], basic zinc borate [ZnB₄O₇.2ZnO], zinc borate [2ZnO.3B₂O₃.3.5H₂O], or mixtures thereof. Preferably, the zinc borate compound is zinc borate [2ZnO.3B₂O₃.3.5H₂O], for example, “Borogard® ZB fine” available from U.S. Borax, Inc.

Zinc borate can be prepared by melting a mixed starting material of zinc oxide and boric acid or double-decomposing the aqueous solution of the mixed starting material.

Preferably, the coating composition contains from 0.5 to 4.75 wt %, more preferably from 0.5 to 4.0 wt %, and most preferably from 1.5 to 2.5 wt %, based on total weight of the powder coating composition, of a zinc borate compound.

The components of the present invention are mixed, extruded and ground by conventional techniques employed in the powder coatings art familiar to a person of ordinary skill in the art. The only limitation being that the alkanolamine, when comprised in the composition according to the invention, is not reacted with either the curing agent or the epoxy resin prior to being combined with any of the additional powder coating components. In addition, pre-blending the alkanolamine with the other powder coating components is believed to be acceptable as long as the alkanolamine is not permitted to react with any of the components with which the alkanolamine is being pre-blended.

Typically, all of the components of the present powder coating formulation are added to a mixing container and mixed together. The blended mixture is then melt blended, for example, in a melt extruder. The extruded composition is then cooled and broken into chips and ground to a powder. The ground powder is subsequently screened to achieve the desired particle size, for example, an average particle size of 20 to 200 μm.

In preparing the zinc borate containing powder coating composition of the present invention, a predetermined amount of the zinc borate compound may be added, for example, to the epoxy resin and further components of the composition according to the invention, and then premixed. The premix is then extruded, cooled, and thereafter pulverized and classified.

The composition according to the invention may also be prepared by spraying from supercritical solutions, NAD “non-aqueous dispersion” processes or ultrasonic standing wave atomization process.

Furthermore, specific components of the powder coating composition according to the invention, for example, additives, pigment, fillers, may be processed with the finished powder coating particles after extrusion and grinding by a “bonding” process using an impact fusion. For this purpose, the specific components may be mixed with the powder coating particles. During blending, the individual powder coating particles are treated to softening their surface so that the components adhere to them and are homogeneously bonded with the surface of the powder coating particles. The softening of the powder particles' surface may be done by heat treating the particles to a temperature, e.g., the glass transition temperature Tg of the composition, in a range, of e.g., 50 to 110° C. (122 to 230° F.). After cooling the mixture the desired particle size of the resulted particles may be proceed by a sieving process.

The powder coating compositions of the present invention can be readily applied to metallic and non-metallic substrates, that either have, or have not, been preheated. The compositions of the present invention can be used to coat metallic substrates including, but not limited to, steel, brass, aluminum, chrome, and mixtures thereof. Examples are pipelines, for example, the internal and/or external surfaces of steel pipes, structural steel used in concrete or in marine environments, storage tanks, valves and oil production tubing and casings. Preferably, the structural steel coated is a pipeline. The compositions of the present invention can also be used to coat iron containing metallic substrates, such as, steel, when such substrates are subjected to the method of cathodic protection in accordance with the present invention.

The powder coating composition according to this invention can be applied also to substrate surfaces that have been less than ideally prepared include, for example, steel surfaces that have been blasted but not acid rinsed, pre-heated to a lower than normal application temperature, or cleaned but not chemically pre-treated. In addition, the good adhesive properties of this invention enable the coating compositions to adhere to oily and scaly surfaces, such as, those encountered with steel strapping and other marginally clean metallic substrates.

Depending upon the requirements placed upon the coated substrate, the surface of the substrate may be subjected to a mechanical treatment, such as blasting followed by, in case of metal substrates, acid rinsing, or cleaning followed by chemical treatment.

The powder coating composition of this invention may be applied by, e.g., electrostatic spraying, electrostatic brushing, thermal or flame spraying, fluidized bed coating methods, flocking, tribostatic spray application and the like, also coil coating techniques, all of which are known to those skilled in the art.

Prior to applying the coating composition of the invention the substrate may be grounded but not pre-heated, so that the substrate is at an ambient temperature of about 25° C. (77° F.).

In certain applications, the substrate to be coated may be pre-heated before the application of the powder composition, and then either heated after the application of the powder composition or not. For example, gas is commonly used for various heating steps, but other methods, e.g., induction heating, microwaves, infra red (IR), near infra red (NIR) and/or ultra violet (UV) irradiation are also known.

The coating composition of the present invention may, for example, be applied by pre-heating the substrate to a temperature ranging from 170 to 260° C. (338 to 500° F.) using means familiar to a person of ordinary skill in the art. The pre-heated substrate may then, for example, dipped in a fluidized bed containing the powder coating composition of the present invention. The composition coated onto the substrate is then post-cured, for example, by means and conditions mentioned below.

After being applied, the coating can then be cured or post-cured by exposing by convective, gas and/or radiant heating, e.g., IR and/or NIR irradiation, as known in the art, to temperatures of, e.g., 100° C. to 300° C. (212 to 572° F.), preferably 160° C. to 280° C. (320 to 554° F.), object temperature in each case, for, e.g., 2 to 10 minutes in case of pre-heated substrates, and, for example, 4 to 30 minutes in case of non-pre-heated substrates. The powder coating composition can also be cured by high energy radiation known by a skilled person. UV radiation or electron beam radiation may be used as high-energy radiation. Irradiation may proceed continuously or discontinuously.

If the composition according to the invention is used together with unsaturated resins and, optionally photo-initiators or with unsaturated resin containing powders, dual curing may also be used. Dual curing means a curing method of the powder coating composition according to the invention where the applied composition can be cured, e.g., both by high energy radiation such as, e.g., UV irradiation, and by thermal curing methods known by a skilled person.

After being cured, the coated substrate is typically subjected to, for example, either air-cooling, or water quenching to lower the temperature to between, for example, 35 and 90° C. (95 and 194° F.).

The substrate is coated with an effective amount of the present powder coating composition so as to produce a dry film thickness that ranges, for example, from 25 to 750 μm (1 to 30 mils), preferably 50 to 450 μm (2 to 18 mils), from 50 to 125 μm (2 to 5 mils) for thin film coatings and from 150 to 450 μm (6 to 18 mils) for thick film functional coatings. When, for example, a single layer pipe coating that is going to subsequently be protected with cathodic protection is desired, the coating composition of the present invention is applied so as to produce a coating having a thickness, for example, of 250 to 450 μm (10 to 18 mils).

The powder coating compositions according to the invention can be applied directly on the substrate surface as a primer coating or on a layer of a primer which can be a liquid or a powder based primer. The powder coating compositions according to the invention can also be applied as a coating layer of a multilayer coating system based on liquid or powder coats, for example, based on a powder or liquid clear coat layer applied onto a color-imparting and/or special effect-imparting base coat layer or a pigmented one-layer powder or liquid top coat applied onto a prior coating.

For example, an adhesive and/or a heavy duty protective film, such as a polyethylene lining, a polyolefin, a heavy duty protective urethane coating composition, an epoxy resin coating composition, or the like, and/or finishing layer, such as a coloring layer or another epoxy powder coating composition, may be applied over the coating composition of the present invention. An adhesive, such as Fusabond® adhesive from DuPont, may be used to bond the protective film to the epoxy coating. The variously available adhesives, protective films and finishing layers will be familiar to a person of ordinary skill in the art.

In case of a substrate having a corrodable metal surface a coating of the powder coating composition of the present invention is applied and the substrate can then be polarized as a cathode.

The present invention is further defined in the following Examples. It should be understood that these Examples are given by way of illustration only. From the above discussion and this Example, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth hereinbelow, but rather is defined by the claims contained hereinbelow.

### EXAMPLES

### Test Procedure

### Cathodic Disbondment (CD) Test Procedure

The following cathodic disbandment test procedure was used in generating the data reported in Table 2, steel panels (4×4×¼″) were first blasted to give a profile of 3 to 4 mils, then further treated by being rinsed with phosphoric acid, and then being rinsed with de-ionized water. The panels were then coated with the compositions prepared in accordance with the Examples more clearly set forth hereinbelow with a film thickness of 200 to 300 μm (8 to 12 mils).

Each coating was applied by pre-heating the respective panel to a temperature ranging from 204 to 232° C. (400 to 450° F.) and then dipping the heated panel into a fluidized bed to achieve 200 to 300 μm (8 to 12 mils) thickness, mostly 250 μm. After proper postcure to achieve full cure checked by differential scanning calorimetry (DSC), the panels were water quenched.

A 3 mm diameter hole (defined as holiday) was then drilled through the center of each coated test panel, and a 3.5 in. diameter cylinder was sealed onto the panel. The cylinder was subsequently filled with 3% NaCl solution, and a platinum wire was immersed in the solution. This entire panel-cylinder assembly was then placed in an oven set at 95° C. (203° F.), and a voltage of 1.5V (as measured in the solution by a Calomel electrode) was applied across the platinum wire and the test panel for 28 days. At the end of each testing period, the panel was removed from the oven, the NaCl solution was poured out of the cylinder, and the cylinder was detached from the panel.

Upon removing the cylinder, 8 radial cuts away from the holiday were made in the portion of the coating within the cylinder that was in contact with the NaCl coating, and the panel was left for one hour to cool to room temperature. The coating was then removed with a knife by working away from the holiday edge using a levering action. The disbondment from the center of the holiday to edge of the disbonded area was measured, and then averaged. This method follows TransCanada Pipeline spec. TESCOAT FBE Rev.0, which is based on CSA Z245.20-98.

### Water Soak Adhesion Test Procedure

The following water soak testing procedure was utilized in generating the data reported in Table 2. Panels coated by the same procedure described above were placed in a 95° C. (203° F.) bath with deinonized water to level sufficient to fully submerge coated test sample. After 14 or 28 days, remove the test panels. While the test specimen is still warm, use the utility knife to scribe a 30×15 mm rectangle through the coating to the substrate. Air cool the bar to ambient temperature for a minimum of one hour after removal from the bath. Before testing the coating, re-scribe the rectangle, ensuring that the scribe reaches the metal substrate. Insert the utility knife under the coating at the corner of the scribed rectangle and use a levering action to remove the coating. Continue the knife action and levering under the coating until either all the coating in the rectangle is removed or the coating demonstrates a defined resistance. Rate the coating adhesion per CSA Z245.20-98.

### Flexibility Test Procedure

The following flexibility testing procedure was utilized in generating the data reported in Table 2. ⅜″1″×7.75” with a profile of 63 to 100 μm (2.5 to 4.0 mils) bars coated by the same procedure described above with 10 mils of coating were placed in the freezer at −30° C. (−22° F.) for 30 minutes, then remove test bars from the freezer and place the bar in a hydraulic bender with proper degree mandrel and wait the ice on the bar to begin to thaw, immediately bend the bar within 10 seconds. Inspect the bar for cracks, disbondment, or tears visible after reaching ambient temperature. Report the coating flexibility per pipe diameter.

### Example 1

### Manufacture of a Powder Coating Composition of Prior Art and Their Application

Example 1 of Table 1 below illustrates the thermosetting epoxy powder coating compositions without any brominated epoxy prior to the present invention. Example 1 is a sample containing 66.3% epoxy- Epon® 2024 with curing agent of Epicure™ Curing Agent P-101 and dicyandiamide. All amounts are given in percent by weight of total formulation weight.

The ingredients of Example 1 were added to a bag and mixed by agitating for approximately 3 minutes. The mixture was then poured into a hot melt extruder, the extruded composition is then cooled on water cooled chill rollers and further ground using a Bantam grinder so that particles having a size range of 2-100 micrometer with an average particle size of 40 micrometer were produced. The coating compositions of Example 1 was then applied to a 4×4×¼″ steel panel that had been blasted.

The process of applying the coating composition of Example 1 involved heating of the phosphoric acid rinsed panel to a metal temperature 232° C. (450° F.) at an oven setting of 243° C. (470° F.), and then dipping the panel into a fluidized bed containing the powder coating composition based on example 1, to achieve a film thickness of 250 μm. The coated panel was then post-cured in an oven set at a temperature of 243° C. (470° F.) for 3 minutes. After being cured, the panel was subjected to the cathodic disbondment and water soak adhesion test described in the above.

As shown in Table 2 Example 1, it has a Tg of 109° C. (228.2° F.). When tested at 95° C. (203° F.) after 14 days, it has large cathodic disbandment (18.0 mm) and poor water soak adhesion of 3 per CSA Z24520-98. After 28 days test, the cathodic disbandment is 25.6 mm and water soak adhesion is 5 per CSA Z245.20-98.

### Example 2-3

### Manufacture of Powder Coating Compositions according to the Invention and Their Application

Examples 2-3 of Table 1 below illustrate the brominated epoxy containing thermosetting epoxy powder coating compositions of the present invention. Example 2 is a sample containing 59.6% brominated epoxy-Epon® 1183. Example 3 is a comparative example that contains 57.8% brominated epoxy-EPOKUKDO® YDB408 of KUKDO Chemical CO. LTD. For examples 2 and 3, the epoxy curing agent is dicyandiamide and 2 MI curing agent. All amounts are given in percent by weight of total formulation weight.

The ingredients comprising the example 2-3 coating compositions of Table 1 were added to a bag and mixed by agitating for approximately 3 minutes. The mixture was then poured into a hot melt extruder, the extruded composition is then cooled on water cooled chill rollers and further ground using a Bantam grinder so that particles having a size range of 2-100 microns with an average particle size of 40 microns were produced. Each of coating compositions of Examples 2-3 of Table 1 was then applied to separate 4×4×¼″ steel panels that had been blasted.

Coating composition example 2 was applied by preheating the acid-treated panel at 232° C. (450° F.) to a metal temperature of 204° C. (400° F.), and then dipping the panel into a fluidized bed containing the powder coating composition example 2 listed in Table 1. The coated panel was then post-cured in an oven set at a temperature of 204° C. (400° F.) for 10 minutes. After being cured, each panel was subjected to the cathodic disbandment and water soak adhesion test described in the above. The final cured film thickness is around 250 μm.

Coating composition example 3 was applied by preheating the acid-treated panel at 243° C. (470° F.) to a metal temperature of 232° C. (450° F.), and then dipping the panel into a fluidized bed containing the powder coating composition example 3 listed in Table 1. The coated panel was then post-cured in an oven set at a temperature of 243° C. (470° F.) for 2 minutes. After being cured, each panel was subjected to the cathodic disbandment and water soak adhesion test described in the above. The final cured film thickness is about 250 μm.

TABLE 1
Powder Coating Compositions

| Ingredient | Example 1 | Example 2 | Example 3 |
|---|---|---|---|
| Epon ™ Resin 2024 (Resolution | 66.3 | 8 | 0 |
| Performance Products, LLC)¹ | | | |
| Epon ™ Resin 1007 (Resolution | 0 | 0 | 14.2 |
| Performance Products, LLC)² | | | |
| Epon ™ Resin 1183 (Resolution | 0 | 59.6 | 0 |
| Performance Products, LLC)³ | | | |
| EPOKUKDO ® YDB-408 (KUKDO | 0 | 0 | 57.8 |
| Chemical CO. LTD)³ | | | |
| Epicure ™ Curing Agent P-101 | 0.8 | | 0 |
| (Resolution Performance Products, | | | |
| LLC)⁴ | | | |
| Dicyandiamide curing agent | 0.6 | 1 | 1 |
| (Degussa) | | | |
| Durite ® SD 357B (Borden | 0.8 | 7 | 2.6 |
| Chemicals, Inc.)⁵ | | | |
| Actiron 2MI Disperse (Synthron, | 0 | 0.4 | 0.4 |
| Inc.)⁶ | | | |
| Resiflow 200A flow agent (Estron | 0 | 0.4 | 0.4 |
| Chemical, Inc.) | | | |
| Tris Amino ® (Dow Angus)⁷ | 0.3 | 0.5 | 0.5 |
| Nyad ™ M400 filler | 27.6 | 16.2 | 18.7 |
| (NYCO Minerals, Inc.)⁸ | | | |
| Zeeospheres 400(3 M) | 0 | 2.5 | 0 |
| Zinc Borate (Borogard ® ZB, | 1.7 | 2 | 2 |
| US Borax) | | | |
| Bayferrox ™ 140 iron oxide pigment | 1 | 0.8 | 0.8 |
| (Bayer Corp.) | | | |
| Acrylonitrile/butadiene (Zealloy ® | 0.6 | 1.2 | 1.2 |
| 1411, Zeon Chemical) | | | |
| Cab-o-sil ™ M5 untreated fumed | 0.3 | 0.4 | 0.4 |
| silica (Cabot, Inc.) | | | |

¹A solid bisphenol A/epichlorohydrin epoxy resin containing half a percent weight of the flow control agent, Modaflow ® (Solutia, Inc.).
²A solid bisphenol A/epichlorohydrin epoxy resin.
³A solid brominated bisphenol A/epichlorohydrin epoxy resin
⁴An imidazole adduct.
⁵A phenol-glyoxal condensate curing agent that is also known as TPE (tetra phenol ethane).
⁶2-methyl imidazole
⁷A tris(hydroxymethyl)aminomethane.
⁸A naturally occurring calcium metasilicate.

TABLE 2
Cathodic Disbondment and Water Soak AdhesionTest Results

| | Example | | |
|---|---|---|---|
| | Example 1 | Example 2 | Example 3 |
| Tg (cured powder) | 109° C. | 135° C. | 151° C. |
| Cathodic disbondment | | | |
| 14 days, 95° C. | 18.0 mm | 8.2 mm | 4.5 mm |
| 28 days, 95° C. | 35.6 mm | 12.6 mm | 9.3 mm |
| Water soak adhession | | | |
| 14 days, 95° C. | 3 | 1 | 1 |
| 28 days, 95° C. | 5 | 1 | 1 |
| Flexibility (0° C.) | 4.1° PD*) | 2.0° PD | 2.5° PD |

*)Flexibility for example 1 was done at −30° C.

Table 2 which contains the Tg, cathodic disbondment and water soak adhesion test results of Examples 2 and 3 illustrates that coating compositions containing brominated epoxy resin will give a coating with higher Tg, e.g., 135° C. and 151° C. compared to the Tg of 109° C. for conventional FBE. Although the flexibility is lower than the example 1, a 2 to 2.5° PD is acceptable for pipe installation. The CD performance and water soak adhesion of example 2 and 3 were significantly better than Example 1 which contains 0% brominated epoxy resin.

Examples 4-7 of Table 3 below illustrate the brominated epoxy containing thermosetting epoxy powder coating compositions of the present invention with different amount of curing agent and brominated epoxy. Example 4 is a sample containing 55.0% brominated epoxy-EPOKUKDO® YDB-408 and 30.0% of phenolic curing agent-Kukdo KD-448H, both from KUKDO Chemical CO. LTD. Example 5 is an example that contains 10.0% brominated epoxy-Epon1183. Example 6 is an example that contains 50.0% brominated epoxy-EPOKUKDO® YDB408. Example 7 is an example that contains 95.0.0% brominated epoxy-EPOKUKDO® YDB408. All examples 4-7 have dicyandiamide and 2 MI curing agent. All amounts are given in percent by weight of total formulation weight.

The ingredients comprising the example 4-7 coating compositions of Table 3 were added to a bag and mixed by agitating for approximately 3 minutes. The mixture was then poured into a hot melt extruder, the extruded composition is then cooled on water cooled chill rollers and further ground using a Bantam grinder so that particles having a size range of 2-100 microns with an average particle size of 40 microns were produced. The resulting powders were checked their Tg by differential scanning calorimetry.

As shown in Table 3, example 4 which has 30% curing agent has a glass transition temperature of 127° C. for the cured powder. Example 5 which has only 10% brominated epoxy led to a glass transition temperature of 123° C. for the cured powder, as the brominated epoxy content increases (example 6-7), the glass transition temperature of the cured powder increases. An increase in brominated epoxy from 50 to 95% leads to the Tg increase from 132 to 159° C.

TABLE 3
Powder Coating Composition

| Ingredient | Example 4 | Example 5 | Example 6 | Example 7 |
|---|---|---|---|---|
| Epon ® Resin 2024 | 10.0 | 47.0 | 30.1 | 0 |
| (Resolution Performance | | | | |
| Products, LLC)¹ | | | | |
| Epon ® Resin 1163 | 0 | 10.0 | 0 | 0 |
| (Resolution Performance | | | | |
| Products, LLC)² | | | | |
| EPOKUKDO ® | 55.0 | 0 | 50.0 | 95.0 |
| YDB-408 (KUKDO | | | | |
| Chemical CO. LTD)² | | | | |
| Kukdo KD-448H | 30.0 | 0 | 0 | 0 |
| (KUKDO Chemical | | | | |
| CO, LTD)³ | | | | |
| Dicyandiamide curing | 0.15 | 1.2 | 1.74 | 2.3 |
| agent (Degussa) | | | | |
| Durite ® SD 357B | 0.7 | 0.7 | 0.7 | 0.7 |
| (Borden Chemicals, | | | | |
| Inc.)⁴ | | | | |
| Actiron 2MI Disperse | 0.5 | 0.5 | 0.5 | 0.5 |
| (Synthron, Inc.)⁵ | | | | |
| Resiflow 200A flow | 0.4 | 0.4 | 0.4 | 0.4 |
| agent (Estron | | | | |
| Chemical, Inc.) | | | | |
| Nyad ® M400 filler | 2.15 | 39.1 | 15.5 | 0 |
| (NYCO Minerals, Inc.)⁶ | | | | |
| Bayferrox ® 140 iron | 0.8 | 0.8 | 0.8 | 0.8 |
| oxide pigment | | | | |
| (Bayer Corp.) | | | | |
| Cab-o-sil ® M5 | 0.3 | 0.3 | 0.3 | 0.3 |
| untreated fumed silica | | | | |
| (Cabot, Inc.) | | | | |
| Tg (cured powder) | 127° C. | 123° C. | 132° C. | 159° C. |

¹A solid bisphenol A/epichlorohydrin epoxy resin containing half a percent weight of the flow control agent, Modaflow ® (Solutia, Inc.).
²A solid brominated bisphenol A/epichlorohydrin epoxy resin
³A phenolic resin with small amount of 2-methyl imidazole.
⁴A phenol-glyoxal condensate curing agent that is also known as TPE (tetra phenol ethane).
⁵2-methyl imidazole
⁶A naturally occurring calcium metasilicate.

What is claimed is:

1. An epoxy powder coating composition comprising an intimate mixture comprising:
(A) 5 to 99 wt % of at least one bromine functionalized epoxy resin with a bromine content of 5 to 60% based on component (A),
(B) 0.5 to 40 wt % of at least one epoxy curing agent, and
(C) 0.01 to 55 wt % of at least one pigment, filler and/or coating additive,
the wt % based on the total weight of the powder coating composition.

2. The composition of claim 1 additionally comprising 0.02 to 6.0 wt % of at least one alkanolamine as component (D).

3. The composition of claim 2 wherein the alkanolamine is selected from the group consisting of diethanolamines and tris(hydroxymethyl)aminomethanes.

4. The composition of claim 1 additionally comprising 0.5 to 5.0 wt % of at least one zinc borate compound.

5. The composition of claim 4 wherein the zinc borate compound is selected from the group consisting of zinc metaborate [Zn(BO₂)₂], basic zinc borate [ZnB₄O₇.2ZnO], zinc borate [2ZnO.3B₂O₃.3.5H₂O].

6. The composition of claim 1 wherein the bromine content of component (A) is 20 to 55% based on component (A).

7. The composition of claim 1 comprising 25 to 80 wt % of the at least one bromine functionalized epoxy resin of component (A).

8. The composition of claim 1 wherein a brominated bisphenol-A/epichlorohydrin epoxy functional resin is used as component (A).

9. The composition of claim 1 comprising 1.5 to 20 wt % of the at least one epoxy curing agent of component (B).

10. A process of preparation the powder coating composition of claim 1 comprising the steps (a) blending together the components (A), (B) and (C), (b) heating the blended components to a temperature to melt the mixture, (c) extruding the melt mixture, and (d) cooling, braking up and grinding to a powder.

11. The process of claim 10 comprising pre-blending the alkanolamine and/or the zinc borate compound with the other powder coating components in preparing the alkanolamine and/or the zinc borate containing powder coating composition of claim 1

12. A process for powder coating a substrate by applying the powder coating composition of claim 1 on the substrate surface and curing the coating.

13. The process of claim 12 wherein the substrate surface is the internal and/or external surface of pipelines.

14. An article produced by the process of claim 12.

15. An article produced by the process of claim 13.
